(19) United States
(12) Patent Application Publication
(10) Pub. No.: US 2006/0065292 A1
(43) Pub. Date: Mar. 30, 2006

(54) Automatic car wash with high pressure wand

(76) Inventor: Kenneth S. Moore, Lockport, NY (US)

Correspondence Address: JAECKLE FLEISCHMANN & MUGEL, LLP, 190 Linden Oaks, ROCHESTER, NY, 14625-2812, US

(21) Appl. No.: 11/240,709

(22) Filed: Sep. 30, 2005

Related U.S. Application Data
(60) Provisional application No. 60/614,794, filed on Sep. 30, 2004.

(51) Int. Cl. B08B 3/00

(52) U.S. Cl. 134/26; 134/36; 134/29

(57) ABSTRACT

An automatic car wash with a high pressure wand moves the wand slightly back and forth when the wand is spraying to provide a direct spray at an angle to horizontal and lateral axis of the car. The high pressure wand is used only once during each car wash, the other fluids being applied by low pressure pipes and nozzles attached to an overhead gantry which moves from one end of the car to the other usually applying a different type of solution with each pass.

### CROSS REFERENCE TO RELATED APPLICATIONS

This application claims the benefit of U.S. Provisional Application Ser. No. 60/614,794, filed Sep. 30, 2004.

### TECHNICAL FIELD

The present invention relates to automatic car washers, and more particularly, to automatic car washers with high pressure wands.

### BACKGROUND OF THE INVENTION

Automatic car washers have used high pressure wands in the past. Such types of car washers have several objectives including minimizing the cost of each car wash, low maintenance, protecting the care from damage during the washing operation, and providing a clean car at the end of the wash cycle.

It is a principal object of the present invention to improve on prior art automatic car washers by minimizing the cost of each car wash, providing an automatic car wash with relatively low maintenance, protecting the car being washed from damage by the high pressure wand, and providing a more effective cleaning action when the car is being washed.

### SUMMARY OF THE INVENTION

Briefly described is a method of washing a car in an automatic car wash by applying soap to the car with a low pressure spray using an overhead gantry which moves from one end of the car to the other end of the car. Allowing the soap time to chemically act on the dirt on the car and rinsing the car with a low pressure spray while the gantry is moving. A high pressure spray is applied from a wand that moves slightly from side to side while applying the spray.

### BRIEF DESCRIPTION OF THE DRAWINGS

The above-mentioned and other features and advantages of this invention, and the manner of attaining them, will become appreciated and be more readily understood by reference to the following detailed description in conjunction with the accompanying drawings, wherein:

FIG. 1 is a car entrance or end end view of an automatic car wash according to the present invention;

FIG. 2 is an enlarged end view of a portion of an overhead gantry used in the car wash of FIG. 1;

FIG. 3 is the cross-sectional side view of the portion of the gantry shown in FIG. 2;

FIG. 4 is a side view of side cleaning pipes and nozzles used in the car wash of FIG. 1; and

FIG. 5 is cross-sectional view of the obstruction detection apparatus shown in FIG. 2.

It will be appreciated that for purposes of clarity and where deemed appropriate, reference numerals have been repeated in the figures to indicate corresponding features, and that the various elements in the drawings have not necessarily been drawn to scale in order to better show the features of the invention. Also, the term “car” as used herein is meant to include other vehicles such as pickup trucks, SUVs, etc.

### DESCRIPTION OF THE PREFERRED EMBODIMENTS

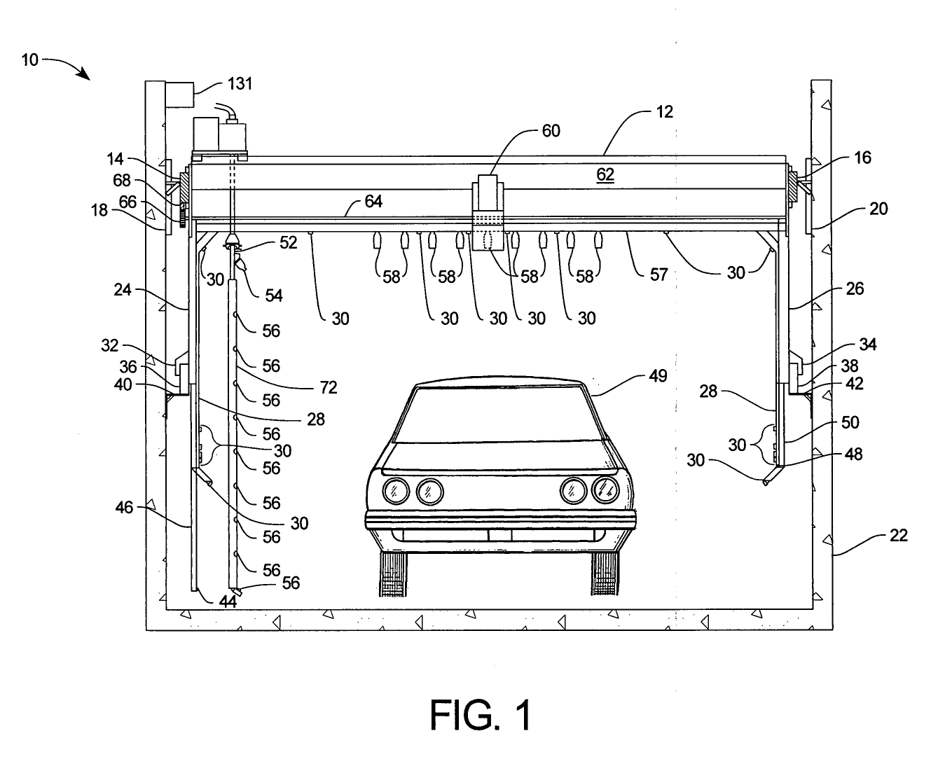

Turning now to the drawings, FIG. 1 is an entrance or end view of an automatic car wash 10 according to the present invention which includes an overhead gantry 12 mounted on side rails 14 and 16 which, in turn, are mounted on brackets 18 and 20 secured to a concrete enclosure 22. The car wash 10 also includes two side panels 24 and 26 which partially enclose five plastic pipes 28 holding cleaning, rinsing, and waxing solutions. The five plastic pipes 28 run under the gantry 12 to span across the width of the car wash 10. The five plastic pipes 28 have various nozzles 30 for spraying the solutions onto a car or other vehicle being washed. The side panels 24 and 26 are attached to brackets 32 and 34 which slide along rails 36 and 38 that are secured to the enclosure 22 by brackets 40 and 42, respectively. An electric eye has a light emitter 44 attached at the bottom of a bracket 46 mounted to the side panel 24, and a photo detector 48 is attached to the bottom of another bracket 50 mounted to the side panel 26.

Advantageously, the light emitter 44 is positioned near the floor of the enclosure 22 while the photo detector 48 is mounted at the height of a door handle of a car 49. With this arrangement, the car wash gantry 12 movement is able to stop a little past each end of the car 49 using the electric eye to detect when the gantry 12 has reached a position where the high pressure wand 52 can move across the width of the car 49 in close proximity to the front end and rear end of the car 49. The diagonal electric eye can detect attachments to the front or rear of a vehicle such as, for example, a snow plow which a horizontal beam might not detect.

The high pressure wand 52 is movable across the gantry 12 and has one high volume nozzle 54 and nine smaller volume nozzles 56, the bottom one being turned at an angle to spray up at the bottom of the car. The high pressure line attached to the wand 52 is also attached to a high pressure line 57 whcih runs across the bottom of the gantry 12 and has nine nozzles 58 which provide high pressure spray to the top of the car.

A motor and gear box 60 is mounted in the center of the gantry 12 to a first cross beam 62. The motor and gearbox 60 selectively turns a drive shaft 64 attached to a gear 66 mounted on the left end or the gantry 12. The gear 66 engages a toothed rail 68 which is attached to the rail 14. Thus, the motor and gear box 60 move the gantry forward and backward in the enclosure 22.

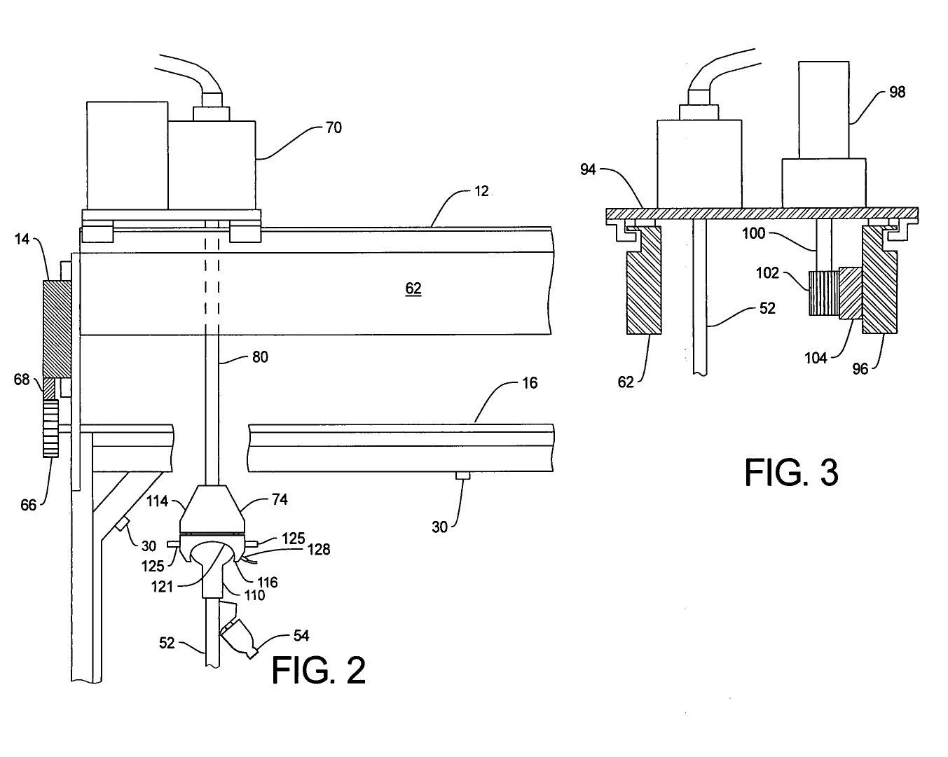

FIG. 2 is an enlarged end view of the left portion of the gantry 12. The high pressure wand 52 is selectively turned by a second motor and gear box 70 to direct the high pressure spray toward the car 49 regardless of the position of the high pressure wand 52 with respect to the enclosure 22. An advantage of the present invention is that the motor and gear box 70 move the high pressure wand 52 back and forth slightly when the wand 52 is in use so that the spray is not only directly onto the car 49, but also the spray moves slightly left and right so that parts of the car that are shadowed by the direct spray are nevertheless sprayed directly with the high pressure spray.

Since the high pressure wand 52 moves around the car, and the wand is positioned based on electronic devices which sense where the car is positioned in the enclosure 22 with respect to right and left and forward and backward, the misreading by one of the sensors or other malfunction is possible which might cause damage to the car 49. To help prevent such damage the high pressure wand 52 is covered with a foam jacket 72 shown in FIG. 1. As further protection to the car an obstruction detection apparatus 74 detects if the wand 52 has made a significant contact with the car. The obstruction detection apparatus 74 is shown in cross section in FIG. 5.

FIG. 3 is the cross-sectional side view of the portion of the gantry 12 shown in FIG. 2. The motor and gear box 70 set on a trolley 94 which spans between the cross beam 62 and a second cross beam 96. A third motor and gear box 98, also mounted on the trolley 94, has a shaft 100 attached to a gear 102 which engages a toothed rail 104 attached to the cross rail 96 to selectively move the trolley 94 and high pressure wand 52 across the width of the front and back of the car 49.

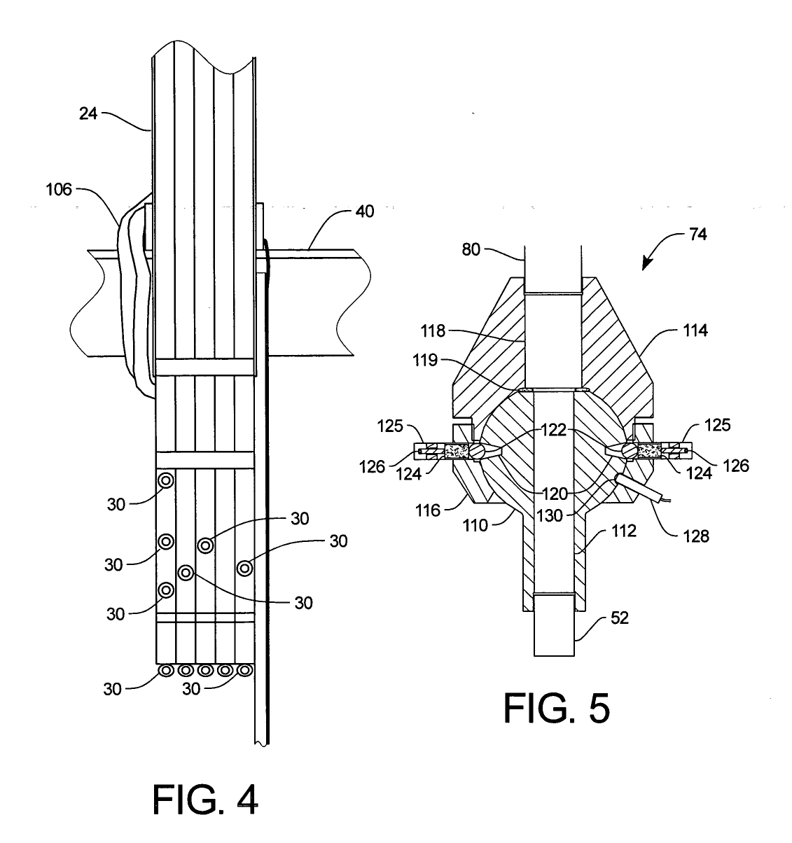

FIG. 4 is a side view of the panel 24 and the five plastic pipes 28 with their nozzles 30. The plastic pipes 28 deliver the solutions from rubber tubing lying 106 on the rail brackets 40. The rubber tubing 106 has not been shown in FIG. 1 on order to clearly show the rail 36, bracket 32 and 40.

In operation the car 49 is driven into the enclosure 22 and two types of soap are sprayed on the car 49 from the appropriate nozzles 30 on the soap pipes as the gantry 12 is moved from the front of the car to the back of the car. After the soap has been sprayed on, the car wash machinery stops for a predetermined time to let the soap loosen and absorb the dirt. Then the gantry moves to the front of the car while straying rinse water onto the car from the appropriate plastic pipe 28. Then the high pressure wand is turned on as the gantry again moves to the back of the car. During this time the high pressure water is sprayed from the nozzles 54, 56 and 58. When the high pressure wand is near the rear of the car, the high pressure wand 52 turns with its nozzles 54 and 56 spraying the car while the gantry 12 is still moving so that the spray follows the contour of the rear corner of the car. After the rear end of the car 49 is reached the gantry 12 is stopped and the nozzles 54 and 56 are used to spray the back end of the car while the high pressure wand 52 is moving across the back end of the care 49 and while the wand 52 is still moving slightly back and forth as described above. The upper high pressure spray from the nozzles 58 is turned off to save water during this time. When the wand 52 reaches the other rear corner of the car, it again turns as the gantry starts to move forward to follow the contour of the corner. As the gantry moves to the front fo the car the upper high pressure nozzles 58 again spray the top of the car.

If the customer has chosen to have the car waxed, the gantry is moved back and forth to put one or both types of waxes on the car 49 from the appropriate plastic pipes 28 and nozzles 30.

The three motors are advantageously synchronous motors which allows the car wash controller to know where the gantry 12 and high pressure wand 52 and its orientation are at all times without needing the sensors and flags used in some prior art car washers. The car wash 10 has a home position for the gantry 12 and high pressure wand 52 and its orientation which does use sensors in order to calibrate the electronics driving the synchronous motors.

The car wash 10 saves time by delivering the soap rinse water and wax through the plastic pipes rather than through the high pressure wand since the gantry 12 can deliver one type of liquid when moving from the front to the back of the car 49 and another type of liquid when moving from the back to the front of the car. The fewer number of movements reduces the maintenance costs and requirements for the car wash 10 compared to some prior art car washes.

Also, the operator of the car wash can shorten the wash cycle by reducing the time that the soap is left on the car 49. For example, in the winter in areas where salt is used to melt snow and ice, car owners often use the car wash to remove the salt residue. Removing the salt residue does not require much time for the soap to remove the dirt, and the wash cycle time can be reduced. While this shortened cycle time is not important during times of slow business, it is very helpful when many cars are waiting to be washed which sometimes occurs in the winter when the weather is relatively mild and car owners have the opportunity to have the salt residue removed.

FIG. 5 is cross-sectional view of the obstruction detection apparatus 74 shown in FIG. 2. The upper pipe of the high pressure wand 52 is screwed into a ball 110 which has a center opening 112. The obstruction detection apparatus 74 has an upper shell 114 and a lower shell 116 which are attached by threads to encase the ball 110. The upper shell 114 has an opening 118 that is in line with the opening 112 of the ball 110. The pipe 80 screws into the opening 118, and a passageway is provided for the cleaning fluids that flow into the high pressure wand 52. An o-ring 119 is in a groove in the ball 110 at the interface between the openings 112 and 118. The ball 110 has four indentations 120, two of which are shown in FIG. 5. The other two indentations are at 45° angles around the circumference of the ball with respect to the indentations 120 shown in FIG. 5 on the side of the lower shell 116 not shown in FIG. 2. The lower shell 116 has an arcuate cutout 121 shown in FIG. 2 that allows the high pressure wand 52 to fold away from the car without damaging the car if the car is driven too far into the stall. Each of the indentations 120 partially receive a ball 122 which is pressed into the indentation 120 by a urethane spring 124 which is enclosed in a cylinder 125. A set screw 126 in the cylinder 125 is used to adjust the static compression of the urethane spring 124. A micro switch 128 is threaded through the bottom shell 116 and lies in an indentation 130 in the ball 110.

In operation the balls 122 are held in the indentations 120 during normal operation of the automatic car wash 10. If the high pressure wand 52 meets an obstruction, the ball 110 turns and the micro switch 128 senses if the turning of the ball is such that the end of the micro switch 128 is no longer in the indentation 130, in which case the high pressure wand 52 is moved away from the car 49 by a car wash controller 131. After the high pressure wand 50 is free of the obstruction, the weight of the high pressure wand 50 rotates the ball 110 back into position. The set screws 126 are used to adjust the pressure of the balls 122 against the indentations 120 so that the amount of force on the high pressure wand 50 necessary to cause the car wash controller to move the high pressure wand 52 away from the car 49 can be controlled.

The embodiments described are chosen to provide an illustration of principles of the invention and its practical application to enable thereby one of ordinary skill in the art to utilize the invention in various embodiments and with various modifications as are suited to the particular use contemplated. Therefore, the foregoing description is to be considered exemplary, rather than limiting, and the true scope of the invention is that described in the following claims.

I claim:

1. A method of washing a car in an automatic car wash comprising the steps of:
a) applying soap to a car being washed with a low pressure spray from an overhead gantry which moves from one end of said car to the other end of said car;
b) allowing the soap time to chemically act on the dirt on said car;
c) rinsing said car with a low pressure spray while said gantry is moving;
d) applying a high pressure spray from said gantry and a wand, said wand moving slightly from side to side while applying said spray.

2. The method of claim 1 further including the step of applying said high pressure spray to each corner of said car while said gantry is moving and said wand is turning from spraying a side of said car to an end of said car.
